(19) United States
(12) Patent Application Publication
(10) Pub. No.: US 2026/0111390 A1
(43) Pub. Date: Apr. 23, 2026

(54) DATA TRANSMISSION APPARATUS, DATA PROCESSING DEVICE, SYSTEM, AND METHOD, AND MEDIUM

(71) Applicant: Suzhou MetaBrain Intelligent Technology Co., Ltd., Suzhou, Jiangsu (CN)

(72) Inventors: Jun YANG, Suzhou, Jiangsu (CN); Tiejun LIU, Suzhou, Jiangsu (CN); Jinglin ZHAN, Suzhou, Jiangsu (CN)

(21) Appl. No.: 19/469,545

(22) PCT Filed: Sep. 30, 2024
(86) PCT No.: PCT/CN2024/122631

§ 371 Date: Sep. 26, 2025

(30) Foreign Application Priority Data
Nov. 29, 2023 (CN) 202311607588.2

(51) Int. Cl. G06F 15/167; G06F 15/173

(52) U.S. Cl. CPC G06F 15/167; G06F 15/17331; G06F 15/17337

(57) ABSTRACT

Disclosed are a data transmission apparatus, a data processing device, system and method, and a medium, which relate to the field of computer technologies. Each memory access module of the data transmission apparatus provided by the present application may directly access a segment of memory address of at least one remote device, and thus to-be-processed data of an acceleration task stored in a memory of the remote device may directly reach the memory access module of the data transmission apparatus from the memory of the remote device; and moreover, a processing result of the acceleration task output by an accelerator connected to a processor may also directly reach the memory of the remote device through the memory access module.

### CROSS-REFERENCE TO RELATED APPLICATION

This application claims priority to Chinese Patent Application No. 202311607588.2 filed on Nov. 29, 2023 in China National Intellectual Property Administration and entitled “Data Transmission Apparatus, Data Processing Device, System, and Method, and Medium”, which is hereby incorporated by reference in its entirety.

### FIELD

The present application relates to the field of computer technologies, and particularly, to a data transmission apparatus, a data processing device, system, and method, and a medium.

### BACKGROUND

Currently, a remote client may utilize an accelerator on a server to execute an acceleration task remotely. Prior to executing the acceleration task by the accelerator on the server, it is necessary to transfer relevant data of the acceleration task provided by the remote client from a memory of the remote client to a memory of the server, and subsequently from the memory of the server to the accelerator. A final execution result of the acceleration task is also required to be transferred from the accelerator to the memory of the server, and then from the memory of the server to the memory of the remote client. Evidently, this process requires repeated transfer of mass data, resulting in increase of both resource consumption and acceleration task processing time.

### SUMMARY

In a first aspect, the present application provides a data transmission apparatus, which includes an address resolution module and a plurality of memory access modules.

Each memory access module is configured to directly connect to a segment of memory address of a corresponding remote device according to a memory request of at least one remote device, and support time-division multiplexing of different remote devices connected to each of the plurality of memory access modules, and each remote devices directly accessed by each memory access module shares a processor connected to the data transmission apparatus and an accelerator connected to the processor.

The address resolution module is configured to: determine, according to an address access request received, a target memory access module corresponding to a target remote device to be accessed by the processor, where the target memory access module has a mapping relationship with a target memory address of the target remote device; and
the target memory access module is configured to: read to-be-processed data of an acceleration task stored in the target memory address to enable the accelerator connected to the processor to process the to-be-processed data; and/or store a processing result of the acceleration task output by the accelerator connected to the processor to the target memory address.

In some embodiments, each memory access module is configured with a segment of memory address of at least one remote device;
any memory access module is configured to: based on an address configuration operation sent by the processor, configure a memory address range carried by the address configuration operation within the memory access module, and establish a remote memory access connection with a current remote device, where the memory address range corresponds to any remote device; and
the address resolution module is configured to: record a mapping relationship between the memory address range, the current remote device, and a memory access module configured with the memory address range.

In some embodiments, any memory access module is configured to: based on an address release operation sent by the processor, disconnect the remote memory access connection from the remote device to enable any memory access module to directly connect to a memory address of another remote device; and
the address resolution module is configured to: delete a corresponding mapping relationship.

In some embodiments, the data transmission apparatus further includes a null address processing module;
the address resolution module is further configured to: in response to determining that no target memory access module having a mapping relationship with the target memory address is present, forward the address access request to the null address processing module; and
the null address processing module is configured to: construct meaningless response data for the address access request according to a preset strategy, and send the meaningless response data to the processor.

In some embodiments, the data transmission apparatus further includes a high-speed interconnection module;
the high-speed interconnection module is configured to: communicate with the processor through a high-speed interconnection interface; and
the high-speed interconnection interface at least includes:
a configuration interface, configured to transmit at least one of an address release operation and an address configuration operation sent by the processor; and
an access interface, configured to transmit the address access request and corresponding response data.

In a second aspect, the present application provides a data processing device, which includes a processor, and an accelerator and a data transmission apparatus which are connected to the processor.

The data transmission apparatus is configured to: directly connect to a segment of memory address of a corresponding remote device according to a memory request of at least one remote device;
the processor is configured to: in response to determining that the data transmission apparatus is directly connected to a memory address of a remote device, generate and send an address access request to the data transmission apparatus by using the accelerator; and
the data transmission apparatus is configured to: according to an address access request received, read a target memory address of a target remote device to be accessed by the processor, and to-be-processed data of an acceleration task stored in the target memory address having a mapping relationship, to enable the accelerator to process the to-be-processed data; and/or store a processing result of the acceleration task output by the accelerator to the target memory address.

In some embodiments, the processor is configured to: allocate a computing request sent by any remote device to a request queue corresponding to the accelerator;
the accelerator is configured to: read the computing request from the request queue, generate an address access request including the computing request, and send the address access request to the data transmission apparatus to acquire the to-be-processed data; and
the accelerator is configured to: process the to-be-processed data to obtain the processing result, generate an address access request including the processing result, and send the address access request to the data transmission apparatus, to return the processing result to the corresponding remote device.

In some embodiments, the processor is further configured to: according to a memory request sent by any remote device, generate an address configuration operation for an idle memory access module in the data transmission apparatus, and send the address configuration operation to the data transmission apparatus;
the data transmission apparatus is configured to: enable the idle memory access module to configure, according to the address configuration operation, a memory address range corresponding to any remote device, carried by the address configuration operation within the idle memory access module, and establish a remote memory access connection with a current remote device; and
the processor is further configured to: in response to determining that the idle memory access module is not found, return a request failure message to the corresponding remote device.

In some embodiments, the processor is further configured to: detect a memory space size of the memory address range according to the memory request sent by any remote device; determine a memory mode matching the memory space size; and manage a corresponding memory space in the memory mode.

In some embodiments, the processor is further configured to: set a configurable address range size for each memory access module in the data transmission apparatus.

In some embodiments, the data processing device includes a plurality of processors and a plurality of data transmission apparatuses; and each processor is connected to a data transmission apparatus and a plurality of accelerators.

In some embodiments, the data transmission apparatus is further configured to: in response to determining that the target memory address is absent, construct, by using a null address processing module in the data transmission apparatus, meaningless response data for a current address access request according to a preset strategy, and send the meaningless response data to the processor.

In a third aspect, the present application provides a data processing system, which includes a plurality of remote devices, a network device, and a data processing device in the second aspect; and the data processing device is connected to the plurality of remote devices through the network device.

In some embodiments, data transmission is performed between the data processing device and the network device, and between the network device and the plurality of remote devices in a remote direct memory access (RDMA) mode.

In a fourth aspect, the present application provides a data processing method, which is applied to a processor in a data processing device. The processor is connected to an accelerator and a data transmission apparatus; and the method includes:
detecting whether the data transmission apparatus is directly connected to a memory address of a remote device;
in response to determining that the data transmission apparatus is directly connected to the memory address of the remote device, generating and sending an address access request to the data transmission apparatus by using the accelerator, to enable the data transmission apparatus, according to an address access request received, to read a target memory address of a target remote device to be accessed by the processor, and to-be-processed data of an acceleration task stored in the target memory address having a mapping relationship, to enable the accelerator to process the to-be-processed data; and/or storing a processing result of the acceleration task output by the accelerator to the target memory address.

In some embodiments, the data processing method further includes:
querying an idle memory access module in the data transmission apparatus according to a memory request sent by any remote device; and
in response to determining that the idle memory access module is found, generating an address configuration operation for the idle memory access module, and sending the address configuration operation to the idle memory access module, to enable the idle memory access module, according to the address configuration operation, to configure a memory address range corresponding to any remote device, carried by the address configuration operation within the idle memory access module and establish a remote memory access connection with a current remote device.

In some embodiments, the data processing method further includes:
detecting a memory space size of the memory address range according to the memory request sent by any remote device;
determining a memory mode matched with the memory space size; and
managing a corresponding memory space in the memory mode.

In some embodiments, the data processing method further includes:
setting a configurable address range size for each memory access module in the data transmission apparatus.

In some embodiments, the data processing method further includes:
receiving meaningless response data sent by the data transmission apparatus, the data transmission apparatus, in response to determining that the target memory address is absent, constructing, by using a null address processing module in the data transmission apparatus, the meaningless response data for a current address access request according to a preset strategy.

In a fifth aspect, the present application provides a non-transient computer-readable storage medium, which is configured to store computer-readable instructions. The computer-readable instructions, when executed by one or more processors, implement the data processing method disclosed above.

### BRIEF DESCRIPTION OF THE DRAWINGS

In order to describe technical solutions in the embodiments of the present application or in the related art more clearly, drawings required to be used in the embodiments or in the related art will be simply introduced below. It is apparent that the drawings described below are only the embodiments of the present application. Other drawings may further be obtained by those of ordinary skill in the art according to these drawings without creative work.

FIG. 1 is a schematic structural diagram of a data transmission apparatus disclosed by the present application;

FIG. 2 is a schematic structural diagram of a data processing device disclosed by the present application;

FIG. 3 is a schematic structural diagram of another data processing device disclosed by the present application;

FIG. 4 is a schematic structural diagram of a data processing system disclosed by the present application;

FIG. 5 is a flowchart of a data processing method disclosed by the present application;

FIG. 6 is a schematic structural diagram of another data processing system disclosed by the present application;

FIG. 7 is a schematic structural diagram of another data transmission apparatus disclosed by the present application;

FIG. 8 is a flowchart of processing a memory access request disclosed by the present application;

FIG. 9 is a memory request flowchart disclosed by the present application;

FIG. 10 is a schematic scenario diagram of a memory mode management disclosed by the present application;

FIG. 11 is a schematic structural diagram of a server provided by the present application;

FIG. 12 is a schematic structural diagram of a terminal provided by the present application; and

FIG. 13 is a schematic structural diagram of a non-transient computer-readable storage medium provided by the present application.

### DETAILED DESCRIPTION

The technical solutions in the embodiments of the present application will be clearly and completely described below with reference to the drawings in the embodiments of the present application. It is apparent that the described embodiments are not all embodiments but only part of the embodiments of the present application. All other embodiments obtained by those of ordinary skill in the art based on the embodiments in the present application without creative work shall fall within the scope of protection of the present application.

Currently, prior to executing an acceleration task by an accelerator on a server, it is necessary to transfer relevant data of the acceleration task provided by a remote client from a memory of the remote client to a memory of the server, and subsequently from the memory of the server to the accelerator. A final execution result of the acceleration task is also required to be transferred from the accelerator to the memory of the server, and then from the memory of the server to the memory of the remote client. Evidently, this process requires repeated transfer of mass data, resulting in increase of both resource consumption and acceleration task processing time. Therefore, the present application provides a data processing solution, to reduce resource consumption and processing time during execution of acceleration tasks.

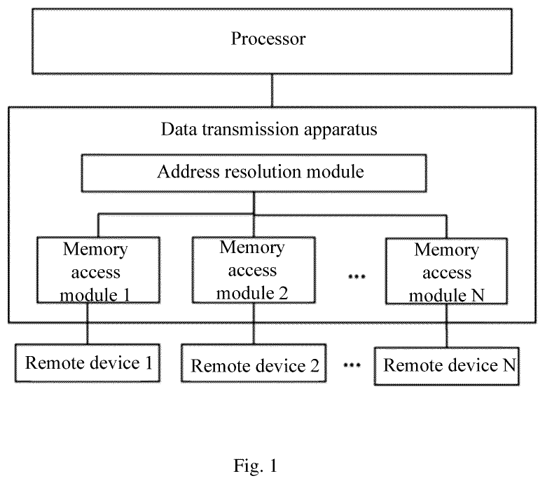

As shown in FIG. 1, some embodiments of the present application provide a data transmission apparatus, which includes an address resolution module and a plurality of memory access modules. Each memory access module is configured to directly access a segment of memory address of at least one remote device. Each memory access module is configured to: directly connect to a segment of memory address of a corresponding remote device according to a memory request of at least one remote device, and support time-division multiplexing of different connected remote devices. The remote devices directly accessed by each memory access module share a processor connected to the data transmission apparatus and an accelerator connected to the processor. The remote device is a remote client, and may be a server, etc. The address resolution module and the memory access modules are hardware logic processing programs located inside an integrated circuit, and may be implemented by a field-programmable gate array (FPGA). The address resolution module receives a memory access request, and queries an on-chip address mapping table according to a memory access address to find a corresponding memory access module. The memory access module achieves a function of communicating with the remote client through remote direct memory access (RDMA), the memory access address and a data length are acquired, and then read or written into a remote memory medium through RDMA.

The address resolution module is configured to: determine a target memory access module corresponding to a target remote device to be accessed by the processor according to an address access request received. The target memory access module has a mapping relationship with a target memory address of a target remote device. In some embodiments, the address resolution module resolves the received address access request to obtain the target memory address of the target remote device to be accessed by the processor, and determines a target memory access module having a mapping relationship with the target memory address. The target remote device is one or more remote devices directly accessed by each memory access module. The target memory address is a memory address of the target remote device configured in the target memory access module.

The target memory access module is configured to: read to-be-processed data of an acceleration task stored in the target memory address to enable the accelerator connected to the processor to process the to-be-processed data; and/or store a processing result of the acceleration task output by the accelerator connected to the processor to the target memory address. The to-be-processed data of the acceleration task includes an artificial intelligence model for processing the acceleration task and model input data.

In some embodiments, a data transmission apparatus having data address resolution and transmission functions is provided. The apparatus is arranged on a server side and is connected to a processor of a server. Each memory access module may be configured with a segment of memory address of at least one remote device (a length of the segment of memory address is determined by the server).

In some implementations, each memory access module is configured with a segment of memory address of at least one remote device. Any memory access module is configured to: based on an address configuration operation sent by the processor, configure a memory address range carried by the address configuration operation within the memory access module, and establish a remote memory access connection with a current remote device. The remote memory access connection may be an RDMA connection, and under this condition, each memory access module is an RDMA module. RDMA is a high-performance and low-latency network communication technology, and may directly access a memory of a remote computer to achieve zero-copy data transmission.

The address resolution module is configured to: record a mapping relationship between the memory address range, the current remote device, and the memory access module configured with the memory address range. An address mapping relationship table may be set in the address resolution module. The address mapping relationship table records mapping relationships between the memory access modules and memory address ranges configured in the memory access modules, as well as information such as IP (Internet Protocol) addresses of related remote devices.

The same memory access module may be time-division multiplexed by a plurality of remote devices connected to it. Any memory access module is configured to: based on an address release operation sent by the processor, disconnect the remote memory access connection from the remote device to enable the memory access module to directly connect to a memory address of another remote device; and the address resolution module is configured to: delete a corresponding mapping relationship.

The memory address range is flexibly set by the processor for each memory access module, and in essence, a configurable address range size for each memory access module does not represent address information; and memory address ranges (configurable address range sizes) corresponding to different memory access modules may be equal, and may also be not equal. A sum of the memory address ranges corresponding to the memory access modules is configured by the processor. For example, the processor allocates a 1 T space to the data transmission apparatus, and the memory access modules in the data transmission apparatus partition this 1T space.

When any remote device sends a memory request to the processor, the processor queries an idle memory access module in the data transmission apparatus according to the memory request sent by any remote device, and in response to determining that the idle memory access module is found, generates an address configuration operation (the address configuration operation is configured to establish a binding relationship between the current remote device and the idle memory access module) for the idle memory access module according to the configurable address range size set for each memory access module, and sends the address configuration operation to the idle memory access module. The idle memory access module, based on the address configuration operation, configures a memory address range corresponding to any remote device, carried by the address configuration operation within the idle memory access module, and establishes a remote memory access connection with the current remote device, whereby the idle memory access module binds with the current remote device. The address resolution module is configured to: record a mapping relationship between the memory address range, the current remote device, and the memory access module configured with the memory address range.

It should be noted that after the processor sets the memory address range for each memory access module, in response to determining that the processor finds the idle memory access module for any remote device, the memory address range configured for the idle memory access module may form a corresponding relationship with the current remote device. In response to determining that the idle memory access module is not found, a request failure message is returned to the corresponding remote device.

To manage a memory space, the processor also detects a memory space size of the memory address range according to the memory request sent by any remote device, determines a memory mode matching the memory space size, and manages a corresponding memory space in the memory mode.

In some implementations, the data transmission apparatus further includes a null address processing module. The null address processing module is also a hardware logic processing program located inside the integrated circuit, and may be implemented by the FPGA. In response to determining that the address resolution module does not find a corresponding memory access module, the null address processing module processes an access request of a central processing unit (CPU), to prevent an operating system from hanging.

The address resolution module is further configured to: in response to determining that no target memory access module having a mapping relationship with the target memory address is present, forward the address access request to the null address processing module; and the null address processing module is configured to: construct meaningless response data for the address access request according to a preset strategy (such as a garbled character generation strategy and/or all-zero character generation strategy), and send the meaningless response data to the processor. When the memory access module is not subjected to address configuration, the null address processing module responds to a request of the processor in the server, whereby the server also may obtain a response in case of no address configuration. Therefore, a closed-loop request processing mechanism is formed to prevent the processor from reporting errors due to prolonged unresponsiveness.

In some implementations, the data transmission apparatus further includes a high-speed interconnection module which is configured to: communicate with the processor through a high-speed interconnection interface (such as a CXL interface). The CXL interface is an interface complying with a compute express link (CXL) technical specification protocol, is a novel high-speed interconnection interface, and may provide higher data throughput and lower latency.

The high-speed interconnection interface at least includes a configuration interface configured to transmit the address release operation and/or address configuration operation sent by the processor, and an access interface configured to transmit the address access request and corresponding response data. In some embodiments, the high-speed interconnection interface includes two types of interfaces, namely CXL.io and CXL.mem. The processor configures modules in the data transmission apparatus through the CXL.io interface, and receives and responds to a request through the CXL.mem interface.

It may be seen that in some embodiments, each memory access module provided by the data transmission apparatus may directly access a segment of memory address of at least one remote device, and thus to-be-processed data of an acceleration task stored in a memory of the remote device may directly reach the memory access module of the data transmission apparatus from the memory of the remote device. Moreover, a processing result of the acceleration task output by an accelerator connected to a processor may also directly reach the memory of the remote device through the memory access module, thereby reducing the number of instances of data migration and thus reducing the resource consumption and processing time during execution of the acceleration task. Remote devices directly accessed by each memory access module may share the processor that is connected to the data transmission apparatus and the accelerator that is connected to the processor, thereby improving a resource utilization rate of the processor and the accelerator.

A data processing device provided by some embodiments of the present application is introduced below, and the data processing device described below and other embodiments herein may be mutually referenced.

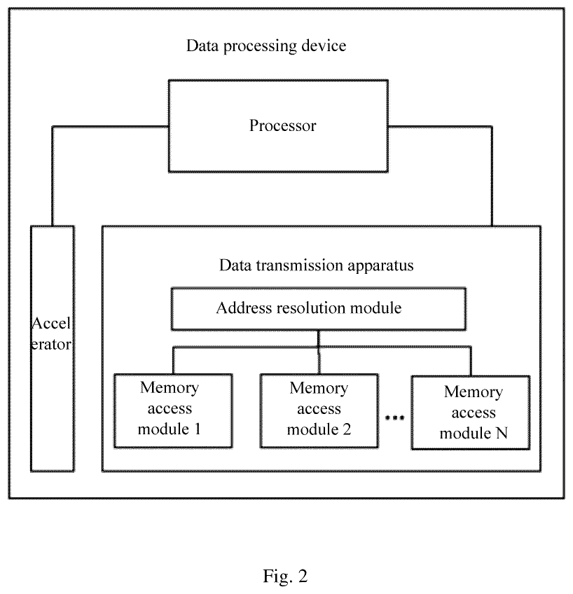

As shown in FIG. 2, some embodiments provide a data processing device, which includes a processor, and an accelerator and a data transmission apparatus which are connected to the processor.

The data transmission apparatus is configured to: directly connect to a segment of memory address of a corresponding remote device according to a memory request of at least one remote device.

The processor is configured to: in response to determining that the data transmission apparatus is directly connected to a memory address of a remote device, generate and send an address access request to the data transmission apparatus by using the accelerator.

The data transmission apparatus is configured to: according to an address access request received, read a target memory address of a target remote device to be accessed by the processor, and to-be-processed data of an acceleration task stored in the target memory address having a mapping relationship, to enable the accelerator to process the to-be-processed data; and/or store a processing result of the acceleration task output by the accelerator to the target memory address.

The data transmission apparatus includes an address resolution module and a plurality of memory access modules; and each memory access module is configured to directly connect to the segment of memory address of the corresponding remote device according to the memory request of at least one remote device, and support time-division multiplexing of different connected remote devices, and the remote devices directly accessed by each memory access module share the processor and the accelerator.

The processor is configured to: in response to determining that the data transmission apparatus is directly connected to the memory address of the remote device, generate and send an address access request to the data transmission apparatus by using the accelerator.

The address resolution module is configured to: resolve the received address access request to obtain a target memory address of a target remote device to be accessed by the processor, and determine a target memory access module having a mapping relationship with the target memory address.

The target memory access module is configured to: read to-be-processed data of an acceleration task stored in the target memory address to enable the accelerator to process the to-be-processed data; and/or store a processing result of the acceleration task output by the accelerator to the target memory address.

In some embodiments, after receiving a computing request sent by any remote device, the processor allocates the computing request sent by any remote device to a request queue corresponding to the accelerator; the accelerator is configured to: read the computing request from the request queue, generate an address access request including the computing request, and send the address access request to the data transmission apparatus to acquire to-be-processed data; and the accelerator is configured to: process the to-be-processed data to obtain a processing result, generate an address access request including the processing result, and send the address access request to the data transmission apparatus to return the processing result to the corresponding remote device.

The accelerator is configured to: read the computing request from the request queue, generate an address access request including the computing request, and send the address access request to the data transmission apparatus to acquire the to-be-processed data; and the accelerator is configured to: process the to-be-processed data to obtain the processing result, generate an address access request including the processing result, and send the address access request to the data transmission apparatus to return the processing result to the corresponding remote device.

In some implementations, the processor is further configured to: query an idle memory access module in the data transmission apparatus according to the memory request sent by any remote device; and in response to determining that the idle memory access module is found, generate an address configuration operation for the idle memory access module, and send the address configuration operation to the idle memory access module; the idle memory access module is configured to: configure, according to the address configuration operation, a memory address range corresponding to any remote device, carried by the address configuration operation within the idle memory access module, and establish a remote memory access connection with a current remote device; and the address resolution module is configured to: record a mapping relationship between the memory address range, the current remote device, and the memory access module configured with the memory address range. The processor is further configured to: according to the memory request sent by any remote device, generate an address configuration operation for an idle memory access module in the data transmission apparatus, and send the address configuration operation to the data transmission apparatus; and the data transmission apparatus is configured to: enable the idle memory access module to configure, according to the address configuration operation, a memory address range corresponding to any remote device, carried by the address configuration operation within the idle memory access module, and establish a remote memory access connection with a current remote device.

In some implementations, the processor is further configured to: in response to determining that the idle memory access module is not found, return a request failure message to the corresponding remote device.

In some implementations, the processor is further configured to: detect a memory space size of the memory address range based on the memory request sent by any remote device; determine a memory mode matching the memory space size; and manage a corresponding memory space in the memory mode.

In some implementations, the processor is further configured to: set a configurable address range size for each memory access module in the data transmission apparatus.

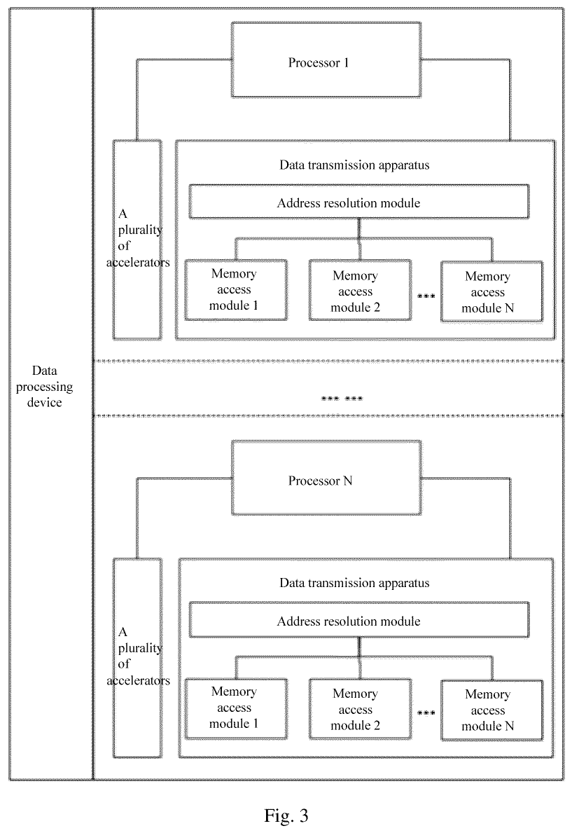

As shown in FIG. 3, some embodiments provide another data processing device, which includes a plurality of processors and a plurality of data transmission apparatuses; and each processor is connected to a data transmission apparatus and a plurality of accelerators.

In some implementations, the data transmission apparatus is further configured to: in response to determining that a target memory address is absent, construct, by using a null address processing module in the data transmission apparatus, meaningless response data for a current address access request according to a preset strategy, and send the meaningless response data to the processor. The data transmission apparatus further includes a null address processing module; an address resolution module is further configured to: in response to determining that no target memory access module having a mapping relationship with the target memory address is present, forward an address access request to the null address processing module; and the null address processing module is configured to: construct meaningless response data for a current address access request according to a preset strategy, and send the meaningless response data to the processor.

It may be seen that in some embodiments, a plurality of remote devices may share the same processor and the accelerators connected to the processor, thereby improving a resource utilization rate of the processor and the accelerators and achieving the following technical effects: to-be-processed data of an acceleration task stored in a memory of the remote device may directly reach a memory access module of the data transmission apparatus from a memory of the remote device; and a processing result of the acceleration task output by the accelerator connected to the processor may also directly reach the memory of the remote device through the memory access module, thereby reducing the number of instances of data migration, simplifying a processing flow, and reducing resource consumption and processing time during execution of the acceleration task.

A data processing system provided by some embodiments of the present application is introduced below, and the data processing system described below and other embodiments described herein may be mutually referenced.

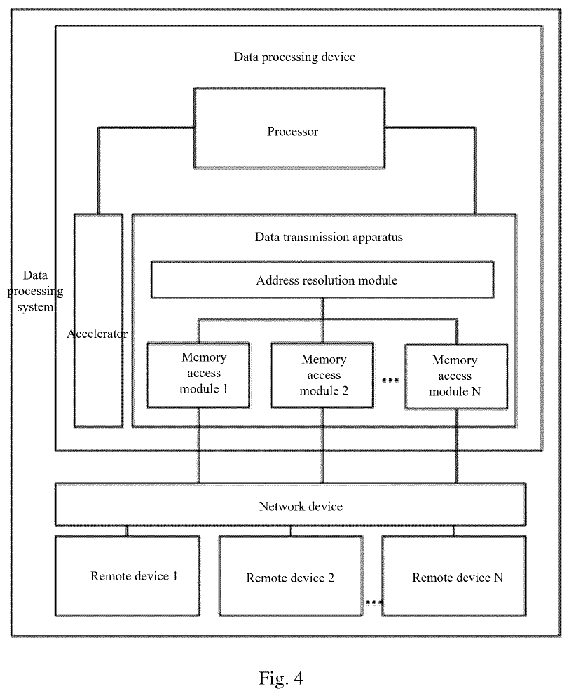

As shown in FIG. 4, some embodiments provide a data processing system, which includes a plurality of remote devices, a network device, and the above data processing device. The data processing device is connected to the plurality of remote devices through the network device. The network device may be a switch, etc. The data processing device may be a server.

The data processing device includes a processor, and an accelerator and a data transmission apparatus which are connected to the processor.

The data transmission apparatus includes an address resolution module and a plurality of memory access modules; and each memory access module is configured to directly connect to a segment of memory address of a corresponding remote device according to a memory request of at least one remote device, and support time-division multiplexing of different connected remote devices, and the remote devices directly accessed by each memory access module share the processor and the accelerator.

The processor is configured to: in response to determining that the data transmission apparatus is directly connected to a memory address of a remote device, generate and send an address access request to the data transmission apparatus by using the accelerator.

The address resolution module is configured to: resolve the received address access request to obtain a target memory address of a target remote device to be accessed by the processor, and determine a target memory access module having a mapping relationship with the target memory address.

The target memory access module is configured to: read to-be-processed data of an acceleration task stored in the target memory address to enable the accelerator to process the to-be-processed data; and/or store a processing result of the acceleration task output by the accelerator to the target memory address.

In some embodiments, after receiving a computing request sent by any remote device, the processor allocates the computing request sent by any remote device to a request queue corresponding to the accelerator; the accelerator is configured to: read the computing request from the request queue, generate an address access request including the computing request, and send the address access request to the address resolution module to acquire to-be-processed data; and the accelerator is configured to: process the to-be-processed data to obtain a processing result, generate an address access request including the processing result, and send the address access request to the address resolution module to return the processing result to the corresponding remote device.

In some implementations, data transmission is performed between the data processing device and the network device, and between the network device and the plurality of remote devices in a RDMA mode.

In some implementations, the data processing system includes a plurality of data processing devices, and each data processing device includes a plurality of processors. Each processor in each data processing device is connected to a data transmission apparatus and a plurality of accelerators.

It may be seen that in some embodiments, the plurality of remote devices may share the same processor and the accelerators connected to the processor, thereby improving a resource utilization rate of the processor and the accelerators and achieving the following technical effects: the to-be-processed data of the acceleration task stored in a memory of the remote device may directly reach the memory access module of the data transmission apparatus from the memory of the remote device; and the processing result of the acceleration task output by the accelerator connected to the processor may also directly reach the memory of the remote device through the memory access module, thereby reducing the number of instances of data migration, simplifying a processing flow, and reducing the resource consumption and processing time during execution of the acceleration task.

A data transmission method provided by some embodiments of the present application is introduced below, and the data transmission method described below and other embodiments described herein may be mutually referenced.

Some embodiments provide a data transmission method. The method is applied to a processor in a data processing device. The processor is connected to an accelerator and a data transmission apparatus; the data transmission apparatus includes an address resolution module and a plurality of memory access modules; and each memory access module is configured to directly connect to a segment of memory address of a corresponding remote device according to a memory request of at least one remote device, and support time-division multiplexing of different connected remote devices, and the remote devices directly accessed by each memory access module share the processor and the accelerator.

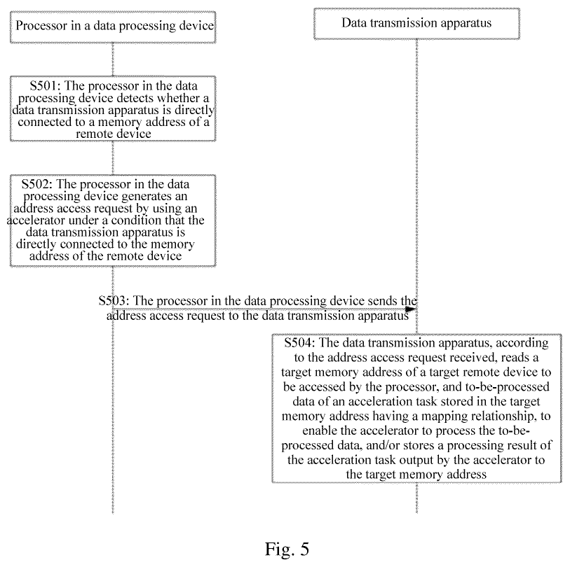

As shown in FIG. 5, the data processing method provided by some embodiments includes:
S501: the processor in the data processing device detects whether the data transmission apparatus is directly connected to a memory address of a remote device;
S502: the processor in the data processing device generates an address access request by using an accelerator in response to determining that the data transmission apparatus is directly connected to the memory address of the remote device;
S503: the processor in the data processing device sends the address access request to the data transmission apparatus; and
S504: the data transmission apparatus, according to the address access request received, reads a target memory address of a target remote device to be accessed by the processor, and to-be-processed data of an acceleration task stored in the target memory address having a mapping relationship, to enable the accelerator to process the to-be-processed data, and/or stores a processing result of the acceleration task output by the accelerator to the target memory address.

In some embodiments, the processor in the data processing device generates and sends an address access request to an address resolution module by using the accelerator. The address resolution module is configured to resolve the received address access request to obtain a target memory address of a target remote device to be accessed by the processor, and determine a target memory access module having a mapping relationship with the target memory address. The target memory access module is configured to read to-be-processed data of an acceleration task stored in the target memory address to enable the accelerator to process the to-be-processed data; and/or store a processing result of the acceleration task output by the accelerator to the target memory address.

In some examples, the data processing method provided by some embodiments includes: the processor in the data processing device detects whether the data transmission apparatus is directly connected to a memory address of a remote device; in response to determining that the data transmission apparatus is directly connected to the memory address of the remote device, the processor generates and sends an address access request to the data transmission apparatus by using an accelerator, to enable the data transmission apparatus, according to an address access request received, to read a target memory address of a target remote device to be accessed by the processor, and to-be-processed data of an acceleration task stored in the target memory address having a mapping relationship, to enable the accelerator to process the to-be-processed data; and/or the processor stores a processing result of the acceleration task output by the accelerator to the target memory address.

The processor in the data processing device receives meaningless response data sent by the data transmission apparatus; and the data transmission apparatus, in response to determining that the target memory address is absent, constructs, by using a null address processing module in the data transmission apparatus, meaningless response data for a current address access request according to a preset strategy.

In some implementations, the processor in the data processing device queries an idle memory access module in the data transmission apparatus according to a memory request sent by any remote device, and in response to determining that the idle memory access module is found, generates an address configuration operation for the idle memory access module, and sends the address configuration operation to the idle memory access module, to enable the idle memory access module to configure, according to the address configuration operation, a memory address range corresponding to any remote device, carried by the address configuration operation within the idle memory access module, and establish a remote memory access connection with a current remote device; and the address resolution module records a mapping relationship between the memory address range, a current remote device, and the memory access module configured with the memory address range.

In some implementations, the processor in the data processing device detects a memory space size of the memory address range according to the memory request sent by any remote device, determines a memory mode matched with the memory space size, and manages a corresponding memory space in the memory mode.

In some implementations, the processor in the data processing device sets a configurable address range size for each memory access module in the data transmission apparatus.

In some implementations, the data transmission apparatus further includes a null address processing module; the processor in the data processing device enables the address resolution module to forward the address access request to the null address processing module in response to determining that no target memory access module having the mapping relationship with the target memory address is present; the processor in the data processing device constructs, by using the null address processing module, meaningless response data for a current address access request according to a preset strategy; and the processor in the data processing device receives the meaningless response data sent by the null address processing module.

In some implementations, the data transmission apparatus further includes a high-speed interconnection module. The processor in the data processing device communicates with the data transmission apparatus through a high-speed interconnection interface of the high-speed interconnection module.

It may be seen that in some embodiments, a plurality of remote devices may share the same processor and the accelerator connected to the processor, thereby improving a resource utilization rate of the processor and the accelerator and achieving the following technical effects: the to-be-processed data of the acceleration task stored in a memory of the remote device may directly reach the memory access module of the data transmission apparatus from the memory of the remote device; and the processing result of the acceleration task output by the accelerator connected to the processor may also directly reach the memory of the remote device through the memory access module, thereby reducing the number of instances of data migration, simplifying a processing flow, and reducing resource consumption and processing time during execution of the acceleration task.

It should be noted that a CXL technology may enable the accelerator such as a graphics processing unit (GPU) and a field-programmable gate array (FPGA) to highly cooperate with the processor, to improve training and inference speeds of an artificial intelligence model.

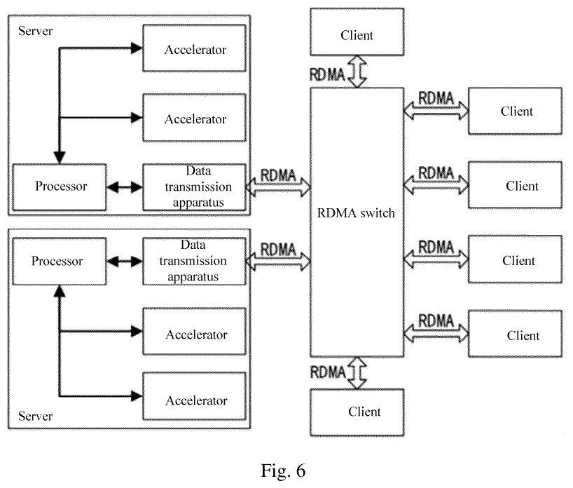

Referring to FIG. 6, a system shown in FIG. 6, combined with features of CXL and RDMA, shows an accelerator sharing cluster, which includes 2 servers providing GPU/FPGA accelerators, a RDMA switch (i.e. a network device), and a plurality of clients (i.e. remote devices) sharing the GPU/FPGA. Such cluster design may enable the GPU/FPGA to be fully utilized, and may also reduce accelerator configuration costs.

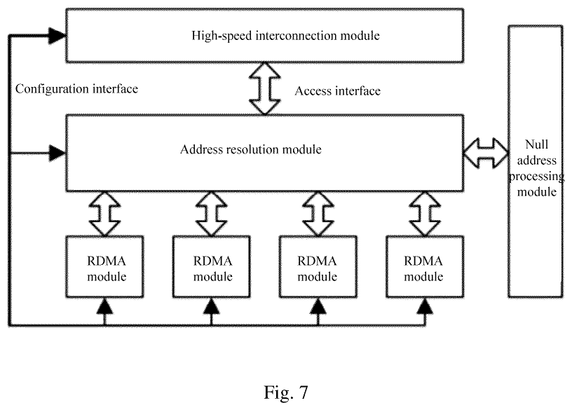

In FIG. 6, a processor in each server is connected to a data transmission apparatus (hereafter referred to as a CXL address decoder). Referring to FIG. 7, the CXL address decoder includes a CXL high-speed interconnection module, an address resolution module, RDMA modules, and a null address processing module.

The CXL high-speed interconnection module supports two types of interfaces, namely CXL.io and CXL.mem. The processor configures or controls the address resolution module, the RDMA modules, and the null address processing module through a CXL.io interface (a configuration interface), and receives and responds to a memory access request (i.e. address access request) of the processor through a CXL.mem interface (an access interface).

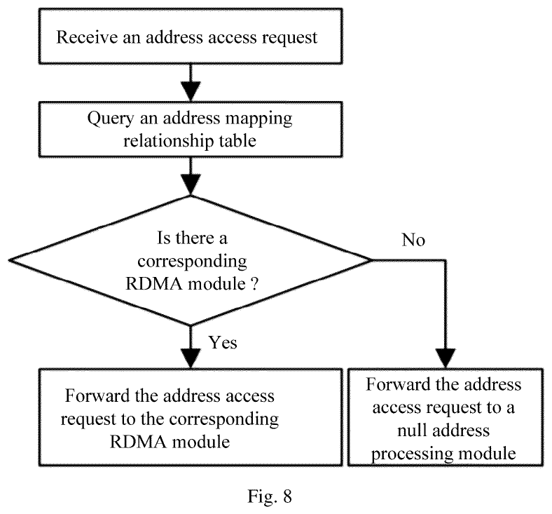

Referring to FIG. 8, the address resolution module receives an address access request from the CXL.mem interface, and resolves a memory address carried in the address access request. An address mapping relationship table is maintained in the address resolution module, and stores mapping relationships from memory address ranges to the RDMA modules; and the address resolution module queries the address mapping relationship table according to a memory address first, and then in response to determining that a corresponding mapping relationship is present in the table, forwards a memory access request to a RDMA module for processing. The address mapping relationship table is configured through a CXL.io interface. If no RDMA module corresponding to the memory address issued from the CXL.mem interface is present in the address mapping relationship table, the memory access request is forwarded to the null address processing module. Since the processor, after issuing the memory access request to the CXL address decoder, is waiting for return of an access result, in case of access timeout, the processor reports an error, to cause a system crash. Therefore, in some embodiments, the null address processing module provides response data without practical meaning for the processor, to prevent the processor from reporting errors.

Each RDMA module functions to access a memory of a remote computer, accesses a memory of a remote client according to a pre-configured setting after receiving the memory access request from the address resolution module, and then returns the access result to the address resolution module. Each RDMA module is configured through a CXL.io interface.

During system initiation of the server, the processor of the server determines an address space range (i.e. memory address range) of each RDMA module according to configuration information for the CXL address decoder from a user, and allocates this information to the CXL address decoder through a CXL.mem interface. However, at this moment, the RDMA module may not be actually used through this address space range, because the RDMA module is only aware of a size of a space it may access, but not aware of an address of this space. That is, an actual memory address that may be accessed is not yet mapped to the RDMA module. Under this condition, the memory access request on the CXL address decoder is processed by the null address processing module.

FIG. 6 is an example diagram of an organization structure of the accelerator sharing cluster. In the figure, a number of the servers and clients may be adjusted as required, the CXL address decoder is installed in each server, and a number of CXL address decoders and a number of accelerators in each server may be adjusted as required. The plurality of clients may remotely share accelerators in the servers through the CXL address decoders.

As shown in FIG. 6 and FIG. 7, the CXL address decoder is an intelligent device, and a plurality of RDMA modules on the CXL address decoder are connected to a switch. After configuring the RDMA modules on the device through CXL.io, the processor immediately triggers the RDMA modules to automatically connect to configured clients, and one RDMA module is connected to at least one client; because the plurality of RDMA modules are arranged, the accelerators on the servers may be shared by the plurality of clients through the CXL address decoders. When one RDMA module is connected to the plurality of clients, the RDMA module is time-division multiplexed by the plurality of clients.

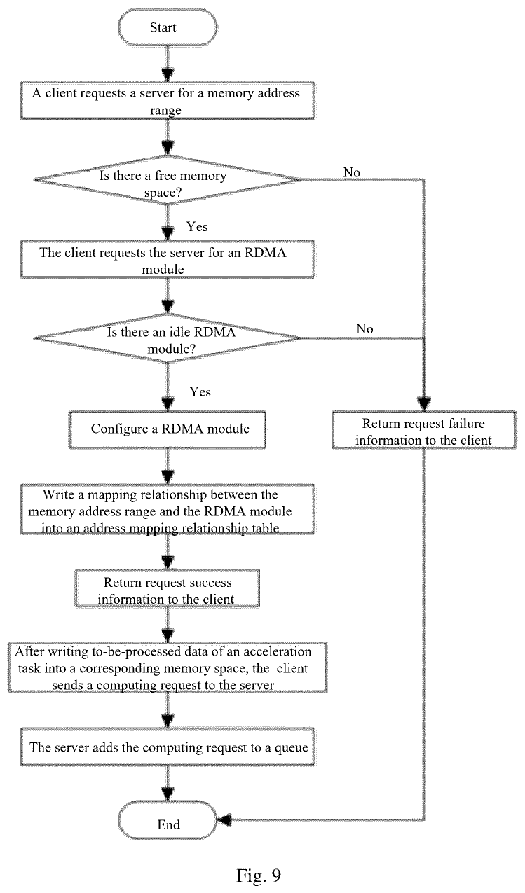

Referring to FIG. 9, after initiation of the CXL address decoder, the client may request the server for a CXL memory address space (memory address range) and the RDMA modules and use accelerator resources on the server. In response to determining that the client requests the server for a 1 TB space for computing, the server checks whether a free CXL memory space (of which a size is specified by the server) is sufficient; after completion of request for the CXL memory space, the client also needs to request for the RDMA modules, and the server configures a CXL memory space range and information of the client to the RDMA modules, triggers the RDMA modules to automatically establish a connection with the client, and writes an address mapping relationship between the memory address range and the RDMA modules in an address mapping relationship table after successful connection. In response to determining that only the free CXL memory space range or only idle RDMA modules are found, the server returns request failure information to the client and needs to release related resources.

Moreover, the server maintains a computing request queue for each group of GPU/FPGA accelerators in the system, and when the client requests the server for computing, the server finds the shortest queue and inserts a new computing request to an end of the queue. When an accelerator has an idle resource, a computing request ranking the first is taken out of the queue in which the accelerator is located, and is processed. The computing request records an actual memory address (a memory address of data on the client) of computing models and data, and GPU/FPGA may directly access the actual memory address. Because a speed of RDMA is far higher than that of a hard disk, a computing efficiency is greatly improved.

In some embodiments, the client exposes a native memory to a server through RDMA and CXL, and the server may directly access a memory of the client like accessing the native memory. Computing models and data on the memory of the client are directly migrated to the GPU/FPGA accelerators, and resources of the server are not occupied. The client provides the computing models and data, and the GPU/FPGA accelerators of the server focus on computing.

After the computing request of the client is completed by the accelerator, a computing result is directly put in the memory of the client, and then the CXL memory range and the RDMA modules, which are occupied by this computing request, are unloaded.

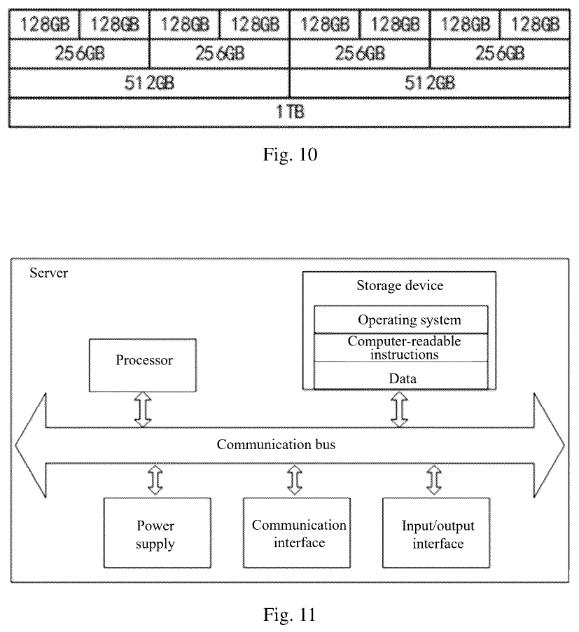

After the CXL memory range on the CXL address decoder is subjected to repeated request and unloading, CXL memory fragments are generated, so the CXL memory range is required to be managed, a size of the CXL memory range is assumed to be 4 TB, and FIG. 10 is an example diagram of management in a memory mode.

As shown in FIG. 11, there are 4 memory space modes (i.e. memory modes): 128 GB, 256 GB, 512 GB, and 1 TB. Each 1 TB space may be configured into any one of the 4 modes. When this 1 TB space is configured into one of the modes, it may not be configured into other modes. When a 1 TB space in the same mode is released, this 1 TB space is reclaimed and restored into a state without any mode.

In an initial state, when a memory space size requested by the client is less than or equal to 128 GB, a first 1 TB space of the CXL address decoder is configured into a 128 GB mode, and then a first 128 GB is allocated to the client. When a second request is less than or equal to 128 GB, a second 128 GB space from this 1 TB space is allocated. In response to determining that the second request is more than 128 GB but less than or equal to 256 GB, a second 1 TB space is configured into a 256 GB mode, and a first 256 GB of this 1 TB space is allocated to the second request.

When a 1 TB space in a certain mode is allocated, a new 1 TB space is configured into this mode, and a space in a size matching the mode is allocated from this 1 TB space to a computing request. The size of the mode in this example may be adjusted as required.

In some embodiments, algorithms may be computed directly on a memory of the client without additional data swapping, thereby not only fully utilizing the GPU/FPGA accelerators but also reducing operational costs of model computation.

An electronic device provided by some embodiments of the present application is introduced below, and the electronic device described below and other embodiments herein may be mutually referenced. The electronic device may be the data transmission apparatus or data processing device described herein.

Some embodiments of the present application disclose an electronic device, which includes:
a storage device, configured to store computer programs; and
a processor, configured to execute the computer programs to implement the method disclosed in any of the above embodiments.

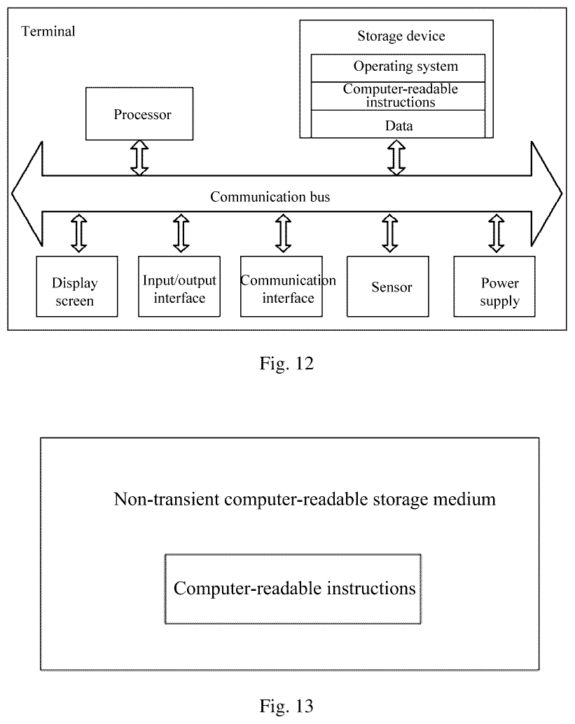

Further, some embodiments of the present application also provide an electronic device. The above electronic device may be a server as shown in FIG. 11, and may also be a terminal as shown in FIG. 12. FIG. 11 and FIG. 12 are respectively a structural diagram of an electronic device according to an exemplary embodiment. The content in the figures may not be considered as any limitations to the application scope of the present application.

FIG. 11 is a schematic structural diagram of a server provided by some embodiments of the present application. The server may include at least one processor, at least one storage device, a power source, a communication interface, an input/output interface, and a communication bus. The storage device is configured to store computer-readable instructions. The computer-readable instructions are loaded and executed by the processor to implement related steps of the data processing method disclosed by any one of the above embodiments.

In some embodiments, the power source is configured to provide working voltages for hardware devices on the server; the communication interface may create a data transmission channel between the server and an external device, and a communication protocol followed by the communication interface is any communication protocol suitable for the technical solutions of the present application, which is not limited herein; and the input/output interface is configured to acquire externally input data or output data to the outside world, and its interface type may be selected according to request requirements, which is not limited herein.

Moreover, the storage device, serving as a carrier of resource storage, may be a read only memory, a random access memory, a magnetic disk, an optical disk, etc., resources stored on the storage device include an operating system, computer-readable instructions and data, etc., and a storage mode may be transient storage or permanent storage.

The operating system is configured to manage and control the hardware devices on the server and the computer-readable instructions, to implement computation and processing of the data in the storage device by the processor, and the operating system may be a Windows Server, Netware, Unix, Linux, etc. Beside those capable of completing the data processing method in any one of the above embodiments, the computer-readable instructions may further include those capable of completing other jobs. The data may include not only data such as request update information but also data such as information of a developer for application programs.

FIG. 12 is a schematic structural diagram of a terminal provided by some embodiments of the present application. The terminal may include but not limited to a smartphone, a tablet computer, a laptop, or a desktop computer.

Generally, the terminal in some embodiments includes a processor and a storage device.

The processor may include one or more processing cores, such as a Quad-core processor, eight-core processor, etc. The processor may be implemented in at least one hardware form from a digital signal processing (DSP), a field-programmable gate array (FPGA), and a programmable logic array (PLA). The processor may also include a host processor and a coprocessor, the host processor is a processor configured to process data in an awake state, and is also called central processing unit (CPU), and the coprocessor is a low power processor configured to process data in a standby state. In some embodiments, the processor may be integrated with a graphics processing unit (GPU), and the GPU is responsible for rendering and drawing of content to be displayed on a screen. In some embodiments, the processor may also include an artificial intelligence (AI) processor, and the AI processor is configured to handle computational operations related to machine learning.

The storage device may include one or more computer-readable storage media which may be non-transient. The storage device may also include a high-speed random access memory, and a non-volatile memory, such as one or more disk storage devices and flash storage devices. In some embodiments, the storage device is at least configured to store the following computer-readable instructions, where after the computer-readable instructions are loaded and executed by the processor, related steps of the data processing method executed by the terminal, which is disclosed in any one of the above embodiments, may be implemented. Moreover, resources stored in the storage device may also include an operating system, data, etc., and a storage mode may be transient storage or permanent storage. The operating system may include Windows, Unix, Linux, etc. The data may include but not limited to update information of application programs.

In some embodiments, the terminal may also include a display screen, an input-output interface, a communication interface, a power source, and a communication bus.

Those skilled in the art may understand that the structure shown in FIG. 12 is not intended to limit the terminal, and the terminal may include components more or fewer than those shown in the figure.

A non-transient computer-readable storage medium provided by some embodiments of the present application is introduced below. FIG. 13 is a schematic structural diagram of a non-transient computer-readable storage medium provided by the present application.

A non-transient computer-readable storage medium described below and other embodiments described herein may be mutually referenced.

A readable storage medium is configured to store computer-readable instructions. The computer-readable instructions, when executed by one or more processors, implement the data processing method disclosed in the above embodiments. The readable storage medium is a non-transient computer-readable storage medium, and, serving as a carrier of resource storage, may be a read only memory, a random access memory, a magnetic disk, an optical disk, etc., resources stored on the storage medium may include an operating system, computer-readable instructions and data, etc., and a storage mode may be transient storage or permanent storage.

Each embodiment in the description is described in a progressive mode, and focuses on the differences from other embodiments, and the identical or similar sections between the embodiments may be mutually referenced.

Steps of the method or algorithm described in the embodiments disclosed herein may be directly implemented by hardware, processor executed software modules, or combination of the hardware and the software modules. The software modules may be configured in a random access memory (RAM), a memory, a read-only memory (ROM), an electrically programmable ROM, an electrically erasable programmable ROM, a register, a hard disk, a removable disk, a compact disc read-only memory (CD-ROM), or any other forms of readable storage media well-known in the technical field.

The principle and implementations of the present application are elaborated with embodiments in the present application, and the descriptions made to the above embodiments are only intended to facilitate understanding of the methods and the core concept of the present application. Those of ordinary skill in the art may make variations to the implementations and the application scope based on the concept of the present application. In conclusion, the content of the description should not be construed as limitations to the present application.

1. A data transmission apparatus, comprising an address resolution module and a plurality of memory access modules,
each memory access module configured with a segment of memory address of at least one remote device, and configured to:
directly connect to a segment of memory address of a corresponding remote device according to a memory request of at least one remote device, and support time-division multiplexing of different remote devices connected to it, and each remote device directly accessed by each memory access module shares a processor connected to the data transmission apparatus and an accelerator connected to the processor; a data processing device accesses a memory of a remote device like accessing local memory; the data processing device comprising: the processor, the accelerator connected to the processor, and the data transmission apparatus;
the address resolution module configured to:
determine, according to an address access request received, a target memory access module with a mapping relationship with a target memory address of a target remote device to be accessed by the processor; the address resolution module setting up an address mapping relationship table recording the mapping relationship between the memory access module and an internet protocol (IP) address of a related remote device; and
the target memory access module configured to:
read to-be-processed data of an acceleration task stored in the target memory address to enable the accelerator connected to the processor to process the to-be-processed data; and/or store a processing result of the acceleration task output by the accelerator connected to the processor to the target memory address.

2. The apparatus according to claim 1, wherein
any of the plurality of memory access modules is configured to:
based on an address configuration operation sent by the processor, configure a memory address range corresponding to any remote device carried by the address configuration operation within any of the plurality of memory access modules, and establish a remote memory access connection with a current remote device; and
the address resolution module is further configured to:
record a mapping relationship between the memory address range, the current remote device, and a memory access module configured with the memory address range.

3. The apparatus according to claim 2, wherein any of the plurality of memory access modules is configured to: based on an address release operation sent by the processor, disconnect the remote memory access connection from the current remote device to enable any of the plurality of memory access modules to directly connect to a memory address of another remote device.

4. The apparatus according to claim 1, further comprising a null address processing module,
the address resolution module further configured to:
in response to determining that no target memory access module having the mapping relationship with the target memory address is present, forward the address access request to the null address processing module; and
the null address processing module configured to:
construct meaningless response data for the address access request according to a preset strategy, and send the meaningless response data to the processor.

5. The apparatus according to claim 1, further comprising a high-speed interconnection module,
the high-speed interconnection module configured to: communicate with the processor through a high-speed interconnection interface; and the high-speed interconnection interface at least comprises:
a configuration interface, configured to transmit at least one of an address release operation or an address configuration operation sent by the processor; and
an access interface, configured to transmit the address access request and corresponding response data.

6. A data processing device, comprising a processor, and an accelerator and a data transmission apparatus which are connected to the processor,
the data transmission apparatus configured to:
directly connect to a segment of memory address of a corresponding remote device according to a memory request of at least one remote device; enabling an idle memory access module, according to an address configuration operation, to configure a memory address range corresponding to any remote device, carried by the address configuration operation within the idle memory access module and establish a remote memory access connection with a current remote device; the data processing device accessing a memory of a remote device like accessing local memory;
the processor configured to:
in response to determining that the data transmission apparatus is directly connected to a memory address of a remote device, generate and send an address access request to the data transmission apparatus by using the accelerator; and
the data transmission apparatus configured to:
according to the address access request received, read a target memory address of a target remote device to be accessed by the processor, and to-be-processed data of an acceleration task stored in the target memory address having a mapping relationship, to enable the accelerator to process the to-be-processed data; and/or store a processing result of the acceleration task output by the accelerator to the target memory address; an address resolution module in the data transmission apparatus setting up an address mapping relationship table recording the mapping relationship between a memory access module and an internet protocol (IP) address of a related remote device.

7. The device according to claim 6, wherein
the processor is configured to: allocate a computing request sent by any remote device to a request queue corresponding to the accelerator;
the accelerator is configured to: read the computing request from the request queue, generate the address access request comprising the computing request, and send the address access request to the data transmission apparatus to acquire the to-be-processed data; and
the accelerator is configured to: process the to-be-processed data to obtain the processing result, generate the address access request comprising the processing result, and send the address access request to the data transmission apparatus to return the processing result to the corresponding remote device.

8. The device according to claim 6, wherein
the processor is further configured to: according to the memory request sent by any remote device, generate the address configuration operation for the idle memory access module in the data transmission apparatus, and send the address configuration operation to the data transmission apparatus;
and
the processor is further configured to: in response to determining that no idle memory access module is found, return a request failure message to the corresponding remote device.

9. The device according to claim 8, wherein the processor is further configured to:
detect a memory space size of the memory address range according to the memory request sent by any remote device;
determine a memory mode matching the memory space size; and
manage a corresponding memory space in the memory mode.

10. The device according to claim 8, wherein the processor is further configured to: set a configurable address range size for each memory access module in the data transmission apparatus.

11. The device according to claim 6, comprising a plurality of processors and a plurality of data transmission apparatuses, each of the plurality of processors is connected to a data transmission apparatus of the plurality of data transmission apparatuses and a plurality of accelerators.

12. The device according to claim 6, wherein the data transmission apparatus is further configured to: in response to determining that the target memory address is absent, construct, by using a null address processing module in the data transmission apparatus, meaningless response data for a current address access request according to a preset strategy, and send the meaningless response data to the processor.

13. (canceled)

14. (canceled)

15. A data processing method, being applied to a processor in a data processing device, the processor connected to an accelerator and a data transmission apparatus, and the method comprises:
detecting whether the data transmission apparatus is directly connected to a memory address of a remote device;
in response to determining that the data transmission apparatus is directly connected to the memory address of the remote device, generating and sending an address access request to the data transmission apparatus by using the accelerator, to enable the data transmission apparatus, according to the address access request received, to read a target memory address of a target remote device to be accessed by the processor, and to-be-processed data of an acceleration task stored in the target memory address having a mapping relationship, to enable the accelerator to process the to-be-processed data; and/or storing a processing result of the acceleration task output by the accelerator to the target memory address; an address resolution module in the data transmission apparatus setting up an address mapping relationship table recording a mapping relationship between a memory access module and an internet protocol (IP) address of a related remote device; and
enabling an idle memory access module, according to an address configuration operation, to configure a memory address range corresponding to any remote device, carried by the address configuration operation within the idle memory access module and establish a remote memory access connection with a current remote device; the data processing device accessing a memory of a remote device like accessing local memory.

16. The method according to claim 15, further comprising:
querying the idle memory access module in the data transmission apparatus according to a memory request sent by any remote device; and
in response to determining that the idle memory access module is found, generating the address configuration operation for the idle memory access module, and sending the address configuration operation to the idle memory access module, to enable the idle memory access module, according to the address configuration operation, to configure the memory address range corresponding to any remote device, carried by the address configuration operation within the idle memory access module and establish the remote memory access connection with the current remote device.

17. The method according to claim 16, further comprising:
detecting a memory space size of the memory address range according to the memory request sent by any remote device;
determining a memory mode matching the memory space size; and
managing a corresponding memory space in the memory mode.

18. The method according to claim 15, further comprising: setting a configurable address range size for each memory access module in the data transmission apparatus.

19. The method according to claim 15, further comprising:
receiving meaningless response data sent by the data transmission apparatus, the data transmission apparatus, under a condition that the target memory address is absent, constructing, by using a null address processing module in the data transmission apparatus, the meaningless response data for a current address access request according to a preset strategy.

20. (canceled)

21. The apparatus according to claim 1, wherein the address resolution module and the plurality of memory access modules are hardware logic processing programs located inside an integrated circuit.

22. The apparatus according to claim 4, wherein the null address processing module is a hardware logic processing program located inside an integrated circuit.

23. The device according to claim 6, wherein the accelerator is at least one of a graphics processing unit (GPU) or a field-programmable gate array (FPGA).
